(19) United States
(12) Patent Application Publication
(10) Pub. No.: US 2011/0053626 A1
(43) Pub. Date: Mar. 3, 2011

(54) Resource allocation apparatus and method for reducing overhead in mobile communication system

(75) Inventors: Jun-Sung Lim, Seoul (KR); Hyun-Kyu Yu, Seoul (KR)

(73) Assignee: Samsung Electronics Co., Ltd., Suwon-si (KR)

(21) Appl. No.: 12/806,963

(22) Filed: Aug. 25, 2010

(30) Foreign Application Priority Data
Aug. 26, 2009 (KR) 10-2009-0079490

(51) Int. Cl. H04B 7/00

(52) U.S. Cl. 455/509

(57) ABSTRACT

A method and apparatus change resource allocation to reduce overhead in a mobile communication system. The method of operating a base station for changing a fixed resource allocation to reduce overhead in a mobile communication system includes determining whether a plurality of fixed resource allocations collide in a fixed resource allocation period. If the fixed resource allocations collide, at least one fixed resource allocation among the plurality of fixed resource allocations is cancelled in the fixed resource allocation period and a determination is made on whether to reallocate the at least one fixed resource allocation before a next fixed resource allocation period. If the at least one fixed resource allocation is reallocated before the next fixed resource allocation period, a control message containing reallocation information changed with respect to the at least one fixed resource allocation is transmitted to a corresponding mobile station. Accordingly, a location of an allocation resource region based on a fixed resource allocation can be effectively changed by using minimum control information.

### CROSS-REFERENCE TO RELATED APPLICATION(S) AND CLAIM OF PRIORITY

The present application claims the benefit under 35 U.S.C. §119 to an application filed in the Korean Intellectual Property Office on Aug. 26, 2009 and assigned Serial No. 10-2009-0079490, the contents of which is herein incorporated by reference.

### TECHNICAL FIELD OF THE INVENTION

The present invention relates to a mobile communication system for resource allocation. More particularly, the present invention relates to an apparatus and method for changing a resource allocation to reduce overhead in a mobile communication system.

### BACKGROUND OF THE INVENTION

With increasing domestic and foreign attention on a 4^{th} Generation (4G) mobile communication, research is being actively conducted on systems for satisfying requirements of 4G mobile communication. Particularly, an Orthogonal Frequency Division Multiplexing (OFDM) scheme, which features high transmission efficiency and simple channel equalization, attracts attention as one of the suitable schemes for the 4G mobile communication system. The OFDM scheme is adopted as a wireless transmission standard for the Institute of Electrical and Electronics Engineers (IEEE)802.16 and other systems.

An Orthogonal Frequency Division Multiple Access (OFDMA) scheme, which allocates different subcarriers for each user, transmits data by splitting the frequency band in use into a plurality of small frequency bands, i.e. into sub-channels and time slots.

Meanwhile, for a time/frequency resource allocation in the OFDMA-based mobile communication system, resources are allocated using a scheduler, and allocation information is transmitted using a control signal. To reduce overhead of the control information, previously allocated regions without particular control information can be reused. That is, a resource region of every frame is fixedly allocated and used until the resource region is changed or released.

Since a period of using the previously allocated region differs in the fixed allocation, the same resource of a specific time point may be allocated to multiple users simultaneously. In this situation, the scheduler changes resource allocation locations of the corresponding users to make them recognize their changed resource allocation regions. When transmitting the changed information, the scheduler needs to send additional control information.

However, conventional methods transmit the additional control information of the changed resource allocation region without taking into account various possible resource collisions in the fixed resource allocation, which may result in overhead.

Accordingly, there is a need for an apparatus and a method for efficiently transmitting the control information required to change the fixed resource allocation region in the mobile communication system.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide an apparatus and a method for a fixed resource allocation in a mobile communication system.

Another aspect of the present invention is to provide a resource allocation apparatus and method for reducing overhead when a fixed resource allocation is changed in a mobile communication system.

Another aspect of the present invention is to provide an apparatus and a method for controlling a roll over on a fixed allocation resource in a mobile communication system.

In accordance with an aspect of the present invention, a method of operating a base station for changing a fixed resource allocation to reduce overhead in a mobile communication system is provided. The method includes determining whether a plurality of fixed resource allocations collide in a fixed resource allocation period. If the fixed resource allocations collide, at least one fixed resource allocation among the plurality of fixed resource allocations is cancelled in the fixed resource allocation period, and a determination regarding whether to reallocate the at least one fixed resource allocation before a next fixed resource allocation period is made. If the at least one fixed resource allocation is reallocated before the next fixed resource allocation period, a control message containing reallocation information changed with respect to the at least one fixed resource allocation is transmitted to a corresponding mobile station.

In accordance with another aspect of the present invention, a method of operating a mobile station for changing a fixed resource allocation to reduce overhead in a mobile communication system is provided. The method includes, if a plurality of fixed resource allocations collide in a fixed resource allocation period, receiving a control message containing allocation information changed with respect to at least one fixed resource allocation. The changed fixed resource allocation is detected on the basis of the changed allocation information, and traffic from a base station is received by using the at least one fixed resource allocation.

In accordance with another aspect of the present invention, a base station apparatus for changing a fixed resource allocation to reduce overhead in a mobile communication system is provided. The apparatus includes a processor for determining whether a plurality of fixed resource allocations collide in a fixed resource allocation period. If the fixed resource allocations collide, the processor cancels at least one fixed resource allocation among the plurality of fixed resource allocations in the fixed resource allocation period and determines whether to reallocate the at least one fixed resource allocation before a next fixed resource allocation period. If the at least one fixed resource allocation is reallocated before the next fixed resource allocation period, the processor transmits a control message containing reallocation information changed with respect to the at least one fixed resource allocation to a corresponding mobile station.

In accordance with another aspect of the present invention, a mobile station apparatus for changing a fixed resource allocation to reduce overhead in a mobile communication system is provided. The apparatus includes a processor for receiving a control message containing allocation information changed with respect to at least one fixed resource allocation if a plurality of fixed resource allocations collides in a fixed resource allocation period. The processor also detects the at least one changed fixed resource allocation on the basis of the changed allocation information and receives traffic from a base station by using the at least one fixed resource allocation.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description taken in conjunction with the accompanying drawings, in which:

FIG. 1 illustrates an example of changing a resource location for a fixed allocation resource to be rolled over according to an embodiment of the present invention;

FIG. 2 illustrates an example of a process for changing a resource location for a fixed allocation resource to be rolled over according to an embodiment of the present invention; and

FIG. 3 illustrates an example of a process for changing a resource location for a fixed allocation resource to be rolled over according to an embodiment of the present invention.

### DETAILED DESCRIPTION OF THE INVENTION

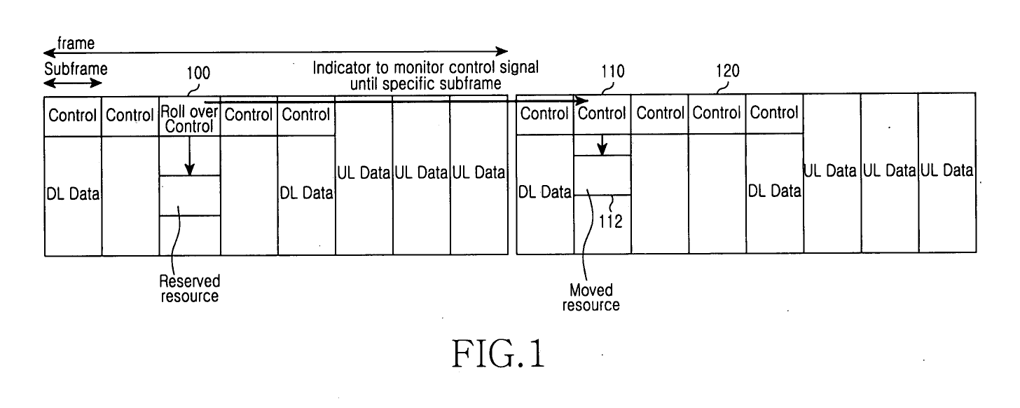

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on the user's or operator's intent and use. That is, the terms used herein should be understood based on the descriptions made herein.

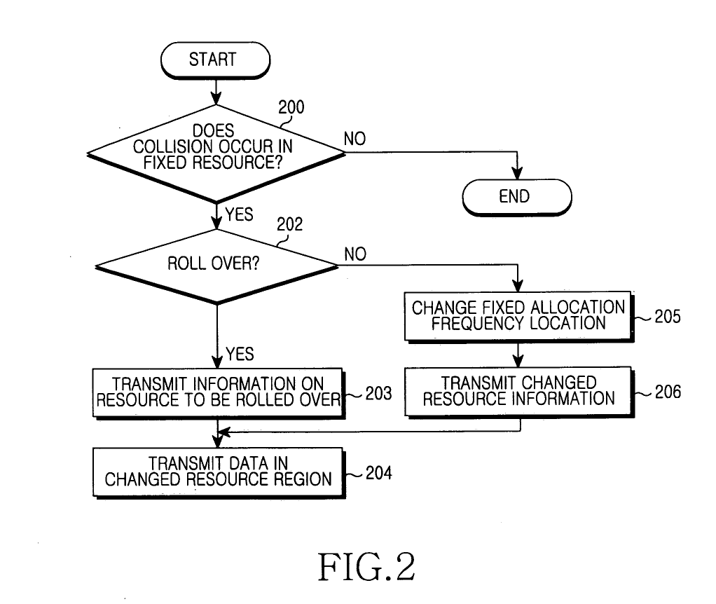

The present invention to be described below relates to an apparatus and method for changing a fixed resource allocation region to reduce overhead in a mobile communication system and also relates to an apparatus and method for determining a resource to be rolled over in a fixed resource allocation. Although a broadband wireless communication system (e.g., the Institute of Electrical and Electronics Engineers (IEEE) 802.16 system) will be described for example in FIG. 1 and FIG. 2, the present invention can also apply to other mobile communication systems.

In the following description, the broadband wireless communication system defines a slot as a specific time duration (i.e., a symbol duration) including a plurality of subcarriers constituting one sub-channel. Several slots constitute one radio resource unit. In other words, one frame consists of a plurality of subframes.

FIG. 1 illustrates an example of changing a resource location for a fixed allocation resource to be rolled over according to an embodiment of the present invention.

Referring to FIG. 1, in a specific frame consisting of a plurality of subframes, a Base Station (BS) transmits a roll over control message to inform a Mobile Station (MS) of continuous monitoring of control information from a subframe 100 to a subframe 120 which is a maximum possible roll over duration as well as temporarily cancellation of a resource to be used (indicated by 100 in FIG. 1). In this situation, the BS may determine the maximum possible roll over duration and report it to the MS, or may pre-determine the maximum possible roll over duration without a special indicator. Thereafter, the BS allocates a new resource (indicated by 112 in FIG. 1) by using the control information in any subframe 110 before the maximum possible roll over duration. For example, if a resource allocated for synchronous Hybrid Automatic Repeat Request (HARQ) retransmission is rolled over, a subframe for the maximum possible roll over duration is determined to be less than a maximum HARQ retransmission time.

FIG. 2 illustrates an example of a process for changing a resource location for a fixed allocation resource to be rolled over according to an embodiment of the present invention.

Referring to FIG. 2, a BS determines whether a collision occurs in a fixed resource allocation in a specific time point or subframe in block 200. If the collision occurs in the fixed resource allocation, the BS determines a fixed resource allocation to be used to change or roll over a frequency resource location of collided fixed allocation resources.

To determine a resource to be rolled over among all pre-allocated regions, at least one resource region to be rolled over can be determined according to an ascending order of the size of all allocated resource regions collided at a scheduler, until the size becomes less than or equal to all available resource regions in a current subframe. Alternatively, at least one resource region to be rolled over can be determined according to a data priority. Alternatively, one or more resource regions to be rolled over can be determined for convenience of scheduling.

In block 202, the BS determines whether the resource is rolled over. If the resource is determined not to be rolled over (i.e., only a frequency location changes within a specific time point), proceeding to block 205, the BS changes a frequency resource location. In block 206, the BS transmits an indicator message including allocation resource information (i.e., an identifier for changing traffic, a location of a changed resource, and such) to be changed to a corresponding MS according to a specific rule.

If the BS determines a fixed allocation resource to be rolled over in block 202, proceeding to block 203, the BS transmits a roll over indication message including information regarding a resource region to be rolled over (e.g., an identifier of traffic to be rolled over, a transmission point of traffic to be rolled over) to the corresponding MS according to a specific rule.

A user who receives the roll over message recognizes that its pre-allocated resource region is cancelled in the current subframe. Herein, the allocation is temporarily cancelled.

In block 204, the BS transmits data of the cancelled fixed allocation region in a resource region changed in a downlink or receives data of the cancelled fixed allocation region in a resource region changed in an uplink.

Thereafter, the procedure of FIG. 2 ends.

A format of the roll over indication message is shown in Table 1 below.

TABLE 1

| | Size | |
|---|---|---|
| Syntax | [bits] | Notes |
| A-MAP IE Type | 4 | Roll over IE indicator |
| Allocation Indicator | 1 | 0b0: No reallocation |
| | | 0b1: Reallocation |
| If (Allocation Indicator == | | |
| 0b0){ | | |
| ACID | 3 | HARQ channel identifier |
| Subframe Offset flag | 1 | |
| If (Subframe Offset flag == | | |
| 0b1) { | | |
| Subframe Offset | 3 | Offset value in the unit of subframe. |
| | | This index doesn't count the DL |
| | | subframe. |
| | | 0b000: 1 subframe |
| | | 0b001: 2 subframes |
| | | 0b010: 3 subframes |
| | | 0b011: 4 subframes |
| | | 0b100: 5 subframes |
| | | 0b101: 6 subframes |
| | | 0b110: 7 subframes |
| | | 0b111: 8 subframes |

}

| | | |
|---|---|---|
| } | | |
| Else { | | |
| ACID | 4 | HARQ channel identifier |
| SPID | 2 | HARQ subpacket identifier for |
| | | HARQ IR. |
| Resource Index | 11 | Indicates location and allocation size |
| | | for the assigned resource. |
| } | | |
| Reserved | TBD | |

Referring to Table 1 above, a roll over Information Element (IE) can be transmitted to report resource allocation information when a fixed resource allocation is temporarily cancelled (‘0b0’) or a rolled-over allocation is reallocated (‘0b1’) at a specific time point by using an allocation indicator. If the allocation indicator is ‘0b0’, a HARQ Channel Identifier (ACID) of a data burst to be rolled over is reported. In this situation, if an allocation rolled over in a specific subframe needs to be allocated in the same manner as a pre-allocated fixed allocation resource, the specific subframe can be specified by using a subframe offset flag (‘0b1’). If the subframe offset flag is set to ‘0b0’, the subframe is reallocated in any subframe within a HARQ maximum retransmission duration. In the subframe to be reallocated, the roll over IE is transmitted, the allocation indicator is set to ‘1’, and a new resource index and HARQ related information (e.g., an ACID and a SubPacket ID (SPID)) are transmitted together.

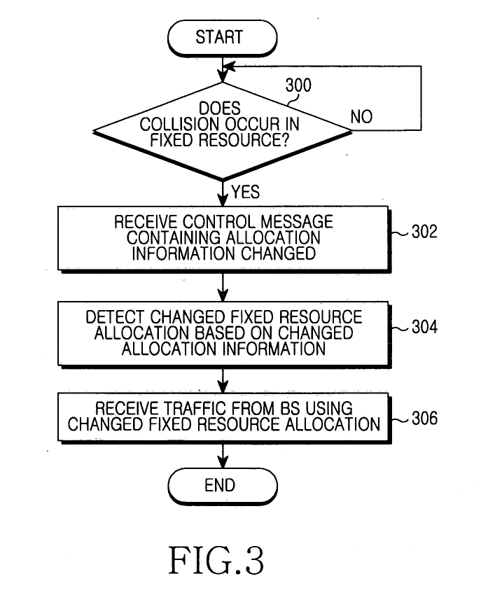

FIG. 3 illustrates an example of a process for changing a resource location for a fixed allocation resource to be rolled over according to an embodiment of the present invention.

Referring to FIG. 3, a MS determines whether a collision occurs in a fixed resource allocation in a specific time point or subframe in block 300.

In block 302, the MS receives a control message containing allocation information changed with respect to fixed resource allocations if a plurality of fixed resource allocations collides in a fixed resource allocation period. The control message contains at least one of an allocation indicator for indicating whether to reallocate one of a temporarily cancelled resource and a rolled-over resource, a subframe offset for indicating a reallocation location of the rolled-over resource, an HARQ Channel Identifier (ACID) of a data burst, a sub-packet ID and a resource index.

In block 304, the MS detects changed fixed resource allocations on the basis of the changed allocation information. That is, the fixed resources are monitored from a subframe in which fixed resource allocations are temporarily cancelled to a predetermined subframe.

In block 306, the MS receives traffic from a BS by using the changed fixed resource allocations.

According to embodiments of the present invention, by comparing control information amounts required for resource changes due to collided resources in a mobile communication system, a location of a fixed resource allocation region can be effectively changed by using minimum control information.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. A method of operating a base station for changing a fixed resource allocation to reduce overhead in a mobile communication system, the method comprising:
determining whether a collision occurs for a plurality of fixed resource allocations collide in a fixed resource allocation period;
in response to determining that the collision occurs:
canceling at least one fixed resource allocation among the plurality of fixed resource allocations in the fixed resource allocation period, and
determining whether to reallocate the at least one fixed resource allocation before a next fixed resource allocation period; and
transmitting a control message containing reallocation information changed with respect to the at least one fixed resource allocation to a corresponding mobile station in response to determining to reallocate the at least one fixed resource allocation before the next fixed resource allocation period.

2. The method of claim 1, further comprising:
in response to determining to not reallocate the at least one fixed resource allocation before the next fixed resource allocation period:
changing a frequency resource allocation with respect to the at least one fixed resource allocation in the fixed resource allocation period, and
transmitting information on the frequency resource allocation changed in the fixed resource allocation period to the corresponding mobile station.

3. The method of claim 1, wherein reallocating the at least one fixed resource allocation before the next fixed resource allocation period comprises reallocating the at least one fixed resource by using one or more subframes between a subframe in which the at least one fixed resource allocation is temporarily cancelled and a predetermined subframe.

4. The method of claim 3, wherein a duration between the subframe in which the at least one fixed resource allocation is temporarily cancelled and the predetermined subframe is a maximum possible roll over duration.

5. The method of claim 4, wherein the maximum possible roll over duration is determined to a maximum Hybrid Automatic Repeat Request (HARQ) retransmission time if a resource allocation for synchronous HARQ retransmission is rolled over.

6. The method of claim 3, wherein information on the predetermined subframe is one of a reported information sent to the corresponding mobile station by using an additional control signal and a pre-known information.

7. The method of claim 1, further comprising selecting at least one fixed resource allocation to be temporarily cancelled among the plurality of fixed resource allocations, wherein selecting the at least one fixed resource allocation to be temporarily cancelled comprises:
sorting the plurality of fixed resource allocations according to one of a size and a priority, until a size of the sorted plurality of fixed resource allocations becomes less than or equal to a size of all available resource regions in the fixed resource allocation period.

8. The method of claim 1, wherein the control message contains at least one of:
an allocation indicator for indicating whether to reallocate one of a rolled-over resource and a temporarily cancelled resource;
a subframe offset for indicating a reallocation location of the rolled-over resource;
a HARQ Channel Identifier (ACID) of a data burst;
a sub-packet identifier (ID); and
a resource index.

9. The method of claim 8, wherein, if the subframe offset is set to a first offset value, the reallocation location of the rolled-over resource is a corresponding indicated subframe, and if the subframe offset is set to a second offset value, the reallocation location is any subframe in a maximum possible roll over duration.

10. The method of claim 8, wherein, if the allocation indicator is set to a first indicator value, the ACID of the data burst and the subframe offset are included in the control message, and if the allocation indicator is set to a second indicator value, the resource index, the ACID of the data burst, and the sub-packet ID are included in the control message.

11. A method of operating a mobile station for changing a fixed resource allocation to reduce overhead in a mobile communication system, the method comprising:
if a plurality of fixed resource allocations collide in a fixed resource allocation period, receiving a control message containing allocation information changed with respect to at least one fixed resource allocation;
detecting the at least one changed fixed resource allocation on the basis of the changed allocation information; and
receiving traffic from a base station by using the at least one changed fixed resource allocation.

12. The method of claim 11, wherein, in the detecting of the at least one changed fixed resource allocation, the at least one fixed resource is monitored from a subframe in which the at least one fixed resource allocation is temporarily cancelled to a predetermined subframe.

13. The method of claim 12, wherein a duration between the subframe in which the at least one fixed resource allocation is temporarily cancelled and the predetermined subframe is a maximum possible roll over duration.

14. The method of claim 13, wherein the maximum possible roll over duration is determined to a maximum Hybrid Automatic Repeat Request (HARQ) retransmission time if a resource allocation for synchronous HARQ retransmission is rolled over.

15. The method of claim 11, wherein the control message contains at least one of:
an allocation indicator for indicating whether to reallocate one of a temporarily cancelled resource and a rolled-over resource;
a subframe offset for indicating a reallocation location of the rolled-over resource;
an HARQ Channel Identifier (ACID) of a data burst;
a sub-packet ID; and
a resource index.

16. The method of claim 15, wherein, if the subframe offset is set to ‘1’, the reallocation location of the rolled-over resource is a corresponding indicated subframe, and if the subframe offset is set to ‘0’, the reallocation location is any subframe in a maximum possible roll over duration.

17. The method of claim 15, wherein, if the allocation indicator is set to ‘0’, the ACID of the data burst and the subframe offset are included in the control message, and if the allocation indicator is set to ‘1’, the resource index, the ACID of the data burst, and the sub-packet ID are included in the control message.

18. A base station for changing a fixed resource allocation to reduce overhead in a mobile communication system, the base station comprising:
a processor configured to:
determine whether collision between a plurality of fixed resource allocations occurs in a fixed resource allocation period,
in response to determining that the collision occurs, cancel at least one fixed resource allocation among the plurality of fixed resource allocations in the fixed resource allocation period and determine whether to reallocate the at least one fixed resource allocation before a next fixed resource allocation period, and
transmit a control message containing reallocation information changed with respect to the at least one fixed resource allocation to a corresponding mobile station in response to determining to reallocate the at least one fixed resource allocation before the next fixed resource allocation period.

19. The base station of claim 18, wherein the processor, in response to determining to not reallocate the at least one fixed resource allocation before the next fixed resource allocation period, is further configured to change a frequency resource allocation with respect to the at least one fixed resource allocation in the fixed resource allocation period and transmit information on the frequency resource allocation changed in the fixed resource allocation period to the corresponding mobile station.

20. The base station of claim 18, wherein the processor is further configured to reallocate the at least one fixed resource by using one or more subframes between a subframe in which the at least one fixed resource allocation is temporarily cancelled and a predetermined subframe.

21. The apparatus of claim 20, wherein a duration between the subframe in which the at least one fixed resource allocation is temporarily cancelled and the predetermined subframe is a maximum possible roll over duration.

22. The base station of claim 21, wherein the maximum possible roll over duration is determined to a maximum Hybrid Automatic Repeat Request (HARQ) retransmission time if a resource allocation for synchronous HARQ retransmission is rolled over.

23. The base station of claim 20, wherein information on the predetermined subframe is one of a reported information sent to the corresponding mobile station by using an additional control signal and a pre-known information.

24. The base station of claim 18, wherein the processor is further configured to:
select at least one fixed resource allocation to be temporarily cancelled among the plurality of fixed resource allocations by sorting the plurality of fixed resource allocations according to one of a size and a priority, until a size of the plurality of sorted fixed resource allocations becomes less than or equal to a size of all available resource regions in the fixed resource allocation period.

25. The base station of claim 18, wherein the control message contains at least one of:
an allocation indicator for indicating whether to reallocate one of a rolled-over resource and a temporarily cancelled resource;
a subframe offset for indicating a reallocation location of the rolled-over resource;
an HARQ Channel Identifier (ACID) of a data burst;
a sub-packet identifier (ID); and
a resource index.

26. The base station of claim 25, wherein, if the subframe offset is set to a first offset value, the reallocation location of the rolled-over resource is a corresponding indicated subframe, and if the subframe offset is set to a second offset value, the reallocation location is any subframe in a maximum possible roll over duration.

27. The base station of claim 25, wherein, if the allocation indicator is set to a first indicator value, the ACID of the data burst and the subframe offset are included in the control message, and if the allocation indicator is set to a second indicator value, the resource index, the ACID of the data burst, and the sub-packet ID are included in the control message.

28. A mobile station for changing a fixed resource allocation to reduce overhead in a mobile communication system, the mobile station comprising:
a processor configured to receive a control message containing allocation information that has changed with respect to at least one fixed resource allocation of a plurality of fixed resource allocations when the plurality of fixed resource allocations collide in a fixed resource allocation period, detect the at least one changed fixed resource allocation based on the changed allocation information, and receive traffic from a base station by using the at least one changed fixed resource allocation.

29. The mobile station of claim 28, wherein the processor is further configured to monitor the at least one fixed resource allocation from a subframe in which the at least one fixed resource allocation is temporarily cancelled to a predetermined subframe.

30. The mobile station of claim 29, wherein a duration between the subframe in which the at least one fixed resource allocation is temporarily cancelled and the predetermined subframe is a maximum possible roll over duration.

31. The mobile station of claim 30, wherein the maximum possible roll over duration is determined to a maximum Hybrid Automatic Repeat Request (HARQ) retransmission time if a resource allocation for synchronous HARQ retransmission is rolled over.

32. The mobile station of claim 28, wherein the control message contains at least one of:
an allocation indicator for indicating whether to reallocate one of a temporarily cancelled resource and a rolled-over resource;
a subframe offset for indicating a reallocation location of the rolled-over resource;
an HARQ Channel Identifier (ACID) of a data burst;
a sub-packet identifier (ID); and
a resource index.

33. The mobile station of claim 32, wherein, if the subframe offset is set to a first offset value, the reallocation location of the rolled-over resource is a corresponding indicated subframe, and if the subframe offset is set to a second offset value, the reallocation location is any subframe in a maximum possible roll over duration.

34. The mobile station of claim 32, wherein, if the allocation indicator is set to a first indicator value, the ACID of the data burst and the subframe offset are included in the control message, and if the allocation indicator is set to a second indicator value, the resource index, the ACID of the data burst, and the sub-packet ID are included in the control message.
